(19) United States
(12) Patent Application Publication
(10) Pub. No.: US 2011/0194390 A1
(43) Pub. Date: Aug. 11, 2011

(54) CONTROL METHOD FOR ADJUSTING LASER POWER OF LASER BEAM IRRADIATING MULTI-LAYER OPTICAL STORAGE MEDIUM AND RELATED CONTROLLER THEREOF

(76) Inventors: Chia-Tao Hsu, Hsinchu County (TW); Chun-Wei Lin, Kao-Hsiung City (TW)

(21) Appl. No.: 12/845,704

(22) Filed: Jul. 28, 2010

Related U.S. Application Data
(60) Provisional application No. 61/302,614, filed on Feb. 9, 2010.

(51) Int. Cl. G11B 20/10

(52) U.S. Cl. 369/47.15; G9B/20.009

(57) ABSTRACT

An exemplary control method for controlling access of a multi-layer optical storage medium includes: receiving a layer jump request for moving a focus point from a first recording layer of the multi-layer optical storage medium to a second recording layer of the multi-layer optical storage medium, and in response to the layer jump request, adjusting a laser power of a laser beam irradiating the multi-layer optical storage medium from a first power level to a second power level power level. The first power level is utilized for reproducing information from the first recording layer, and the second power level is utilized for reproducing information from the second recording layer.

### CROSS REFERENCE TO RELATED APPLICATION

This application claims the benefit of U.S. Provisional Application No. 61/302,614, filed on Feb. 9, 2010 and included herein by reference.

### BACKGROUND

The disclosed embodiments of the present invention relate to controlling assess of an optical storage medium, and more particularly, to a control method for adjusting a laser power of a laser beam irradiating a multi-layer optical storage medium and related control circuit thereof.

Optical storage media are now widely used for data storage. For example, an optical disc, such as a compact disc (CD), a digital versatile disc (DVD) or a Blu-ray disc (BD), is used for storing data due to its high storage capacity, small size and low cost. Regarding a read/write operation performed by an optical storage apparatus (e.g., an optical disc drive), a laser beam generated from a semiconductor laser diode or a light source of an optical pickup unit irradiates on a recording layer of an optical disc via an objective lens to thereby reproducing information from/record information onto the optical disc.

Recently, a dual-layer optical disc with two recording layers is used due its higher storage capacity. For meeting the requirement of recording information onto or reproducing information from different recording layers of the dual-layer optical disc, the focus point of the laser beam is needed to be moved from one recording layer to anther recording layer, which is generally known as “layer jump”. In a conventional design, the laser power of the laser beam for reproducing information from each recording layer of the dual-layer optical disc is maintained at the same power level. In other words, when the optical pickup unit currently generates a laser beam with a specific power level for reproducing information from one recording layer of the dual-layer optical disc, and the optical disc drive receives a layer jump request from a host for moving a focus point from the current recording layer to the other recording layer, the optical pickup unit keeps generating the laser beam with the same specific power level.

However, it is possible that the characteristics of recording layers of a multi-layer optical disc might be different. Using a laser beam with the same read power level may damage the disc or fail to correctly reproduce information from different recording layers of the multi-layer optical disc. For example, a first recording layer of the multi-layer disc may need a laser power level P1 for correctly reproducing information therefrom and a second recording layer may need a different laser power level P2 for reproducing information therefrom. In a case where the focus point on the first recording layer is moved to the second recording layer in response to a layer jump request, the laser power level is still maintained at P1 according to the conventional design. Consequently, as the laser power level P1 is not suitable for the second recording layer, the data reproduction performance of the second recording layer is significantly degraded.

### SUMMARY

In accordance with exemplary embodiments of the present invention, a control method for adjusting a laser power of a laser beam irradiating a multi-layer optical storage medium and related control circuit thereof are proposed to solve the above-mentioned problem.

According to a first aspect of the present invention, an exemplary control method for controlling access of a multi-layer optical storage medium is disclosed. The exemplary control method includes: receiving a layer jump request for moving a focus point from a first recording layer of the multi-layer optical storage medium to a second recording layer of the multi-layer optical storage medium; and in response to the layer jump request, adjusting a laser power of a laser beam irradiating the multi-layer optical storage medium from a first power level to a second power level. The first power level is utilized for reproducing information from the first recording layer, and the second power level is utilized for reproducing information from the second recording layer.

According to a second aspect of the present invention, an exemplary control circuit of an optical storage apparatus is disclosed. The exemplary control circuit includes: an interface unit, arranged to receive a layer jump request for moving a focus point from a first recording layer of a multi-layer optical storage medium to a second recording layer of the multi-layer optical storage medium; and a laser power decision unit, arranged to generate a laser power control signal to a power controller of the optical storage apparatus for adjusting a laser power of a laser beam irradiating the multi-layer optical storage medium from a first power level to a second power level, in response to the layer jump request. The first power level is utilized for reproducing information from the first recording layer, and the second power level is utilized for reproducing information from the second recording layer.

According to a third aspect of the present invention, an exemplary control method for controlling access of a multi-layer optical storage medium is disclosed. The exemplary control method includes: receiving a layer jump request for moving a focus point from a first recording layer of the multi-layer optical storage medium to a second recording layer of the multi-layer optical storage medium; and in response to the layer jump request, generating a laser power control signal to a power controller of an optical storage apparatus for adjusting a laser power of a laser beam irradiating the multi-layer optical storage medium from a first power level to a second power level, wherein the first power level is utilized for identifying information from the first recording layer, and the second power level is utilized for identifying information from the second recording layer.

According to a fourth aspect of the present invention, an exemplary control method for controlling access of a multi-layer optical storage medium is disclosed. The exemplary control method includes: setting a laser power of a laser beam irradiating a first recording layer of the multi-layer optical storage medium to a first power level when reproducing information from the first recording layer; and setting the laser power of the laser beam irradiating a second recording layer of the multi-layer optical storage medium to a second power level when reproducing information from the second recording layer. The first power level is different from the second power level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an optical storage apparatus according to an exemplary embodiment of the present invention.

FIG. 2 is a flowchart illustrating a first exemplary layer jump method for a multi-layer optical storage medium according to the present invention.

FIG. 3 is a flowchart illustrating a second exemplary layer jump method for a multi-layer optical storage medium according to the present invention.

FIG. 4 is a flowchart illustrating a third exemplary layer jump method for a multi-layer optical storage medium according to the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The conception of the present invention is to use different power levels (e.g., read power levels) for a multi-layer optical storage medium's recording layers with different characteristics. For example, a laser power of a laser beam irradiating a first recording layer of the multi-layer optical storage medium is set to a first power level when reproducing information (e.g., identifying information, such as identifying data or address) from the first recording layer, and the laser power of the laser beam irradiating a second recording layer of the multi-layer optical storage medium is set to a second power level different from the first power level when reproducing information (e.g., identifying information, such as data or address) from the second recording layer. Thus, when there is a layer jump request, the laser power of the laser beam will be changed in response to the layer jump request. Further details are described as follows.

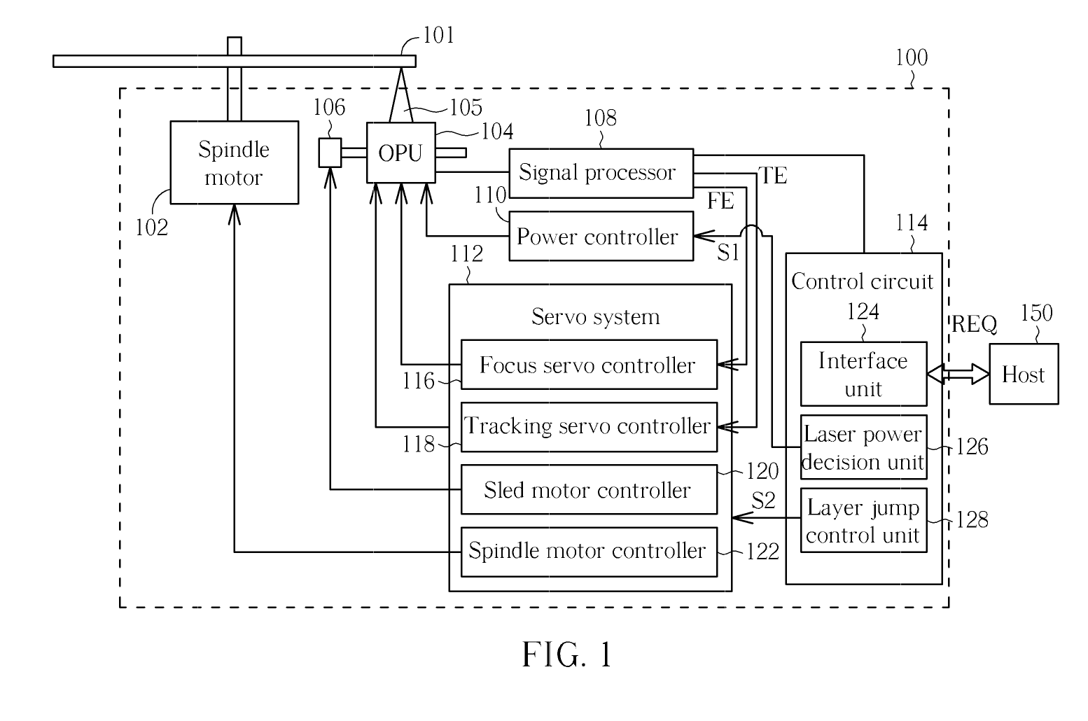

FIG. 1 is a diagram illustrating an optical storage apparatus according to an exemplary embodiment of the present invention. The optical storage apparatus 100 includes, but is not limited to, a spindle motor 102, an optical pickup unit (OPU) 104, a sled motor 106, a signal processor 108, a power controller (e.g., an automatic power controller) 110, a servo system 112, and a control circuit 114. The servo system 112 includes, but is not limited to, a focus servo controller 116, a tracking servo controller 118, a sled motor controller 120, and a spindle motor controller 122. In addition, the control circuit 114 includes, but is not limited to, an interface unit 124, a laser power decision unit 126, and a layer jump control unit 128. It should be noted that only the elements pertinent to the present invention are shown. That is, the exemplary optical storage apparatus 100 may have other elements included therein.

The spindle motor 102 rotates a multi-layer optical storage medium 101 (e.g., a multi-layer optical disc with more than one layer) at a desired rotation speed under the control of the spindle motor controller 122. The OPU 104 generates a laser beam 105 irradiating the multi-layer optical storage medium 101, and may include an objective lens (not shown), a laser light generating system (not shown), an actuator (not shown) holding the objective lens, a photo detector (not shown), and a signal generating unit (not shown). The laser beam 105 is generated from the laser light generating system, and irradiates a recording layer of the multi-layer optical storage medium 101 through the objective lens. The photo detector detects the laser light reflected from the multi-layer optical storage medium 101, and then the signal generating unit generates signals to the signal processor 108 according to an output of the photo detector.

For example, the signals generated from the signal generating unit may include a radio-frequency (RF) signal and basic signals required for producing servo signals such as a focus error signal FE and a tracking error signal TE. The actuator moves the objective lens in a vertical direction (i.e., a thickness direction/interlayer direction of the multi-layer optical storage medium 101) under the control of the focus servo controller 116, and moves the objective lens in a horizontal direction (i.e., a radial direction of the multi-layer optical storage medium 101) under the control of the tracking servo controller 118. The sled motor 106 moves the OPU 104 to a target position for reproducing information from the multi-layer optical storage medium 101 or recording information onto the multi-layer optical storage medium 101 under the control of the sled motor controller 120. The laser power of the laser beam 105 emitted from the OPU 104 is controlled by the power controller 110.

The control circuit 114 is coupled to the signal processor 108, the power controller 110, and the servo system 112, and is utilized for managing the overall operation of the optical storage apparatus 100. For example, the control circuit 114 communicates with a host 150 such as a personal computer, and controls the layer jump operation when receiving a layer jump request/command from the host 150. Details of the layer jump control are described as follows.

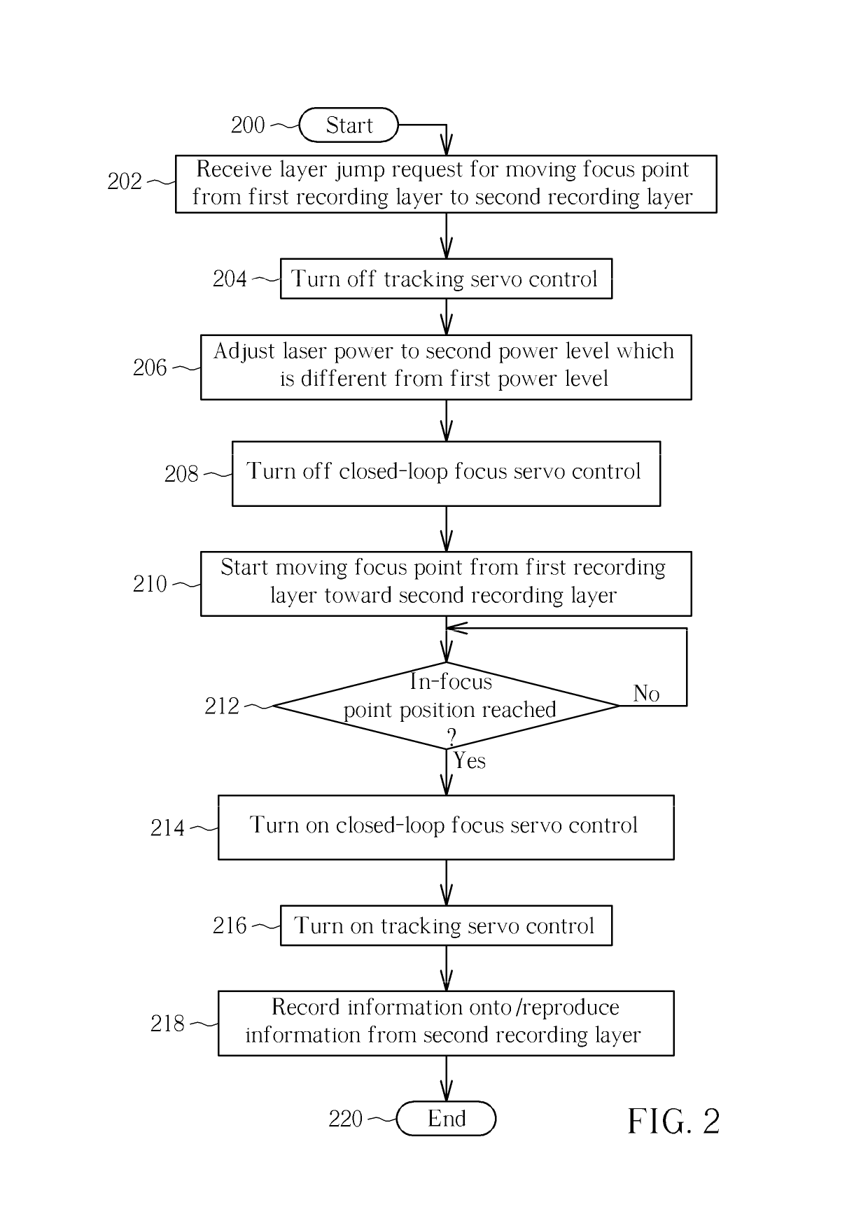

Please refer to FIG. 2 in conjunction with FIG. 1. FIG. 2 is a flowchart illustrating a first exemplary layer jump method for the multi-layer optical storage medium 101 according to the present invention. Provided that the result is substantially the same, the steps are not required to be executed in the exact order shown in FIG. 2. The first exemplary layer jump method performed by the optical storage apparatus 100 includes the following steps.

Step 200: Start.

Step 202: Receive a layer jump request for moving a focus point from a first recording layer of a multi-layer optical storage medium to a second recording layer of the optical storage medium.

Step 204: Turn off a tracking servo control.

Step 206: Adjust a laser power of a laser beam irradiating the multi-layer optical storage medium to a second power level different from a first power level, wherein the first power level is utilized for reproducing information (e.g., identifying information, such as data or address) from the first recording layer, and the second power level is utilized for reproducing information (e.g., identifying information, such as data or address) from the second recording layer.

Step 208: Turn off a closed-loop focus servo control.

Step 210: Start moving the focus point from the first recording layer toward the second recording layer in a thickness direction.

Step 212: Check if the focus point reaches an in-focus point position of the second recording layer. If yes, go to step 214; otherwise, perform step 212 again.

Step 214: Turn on the closed-loop focus servo control.

Step 216: Turn on the tracking servo control.

Step 118: Record information onto or reproduce information from the second recording layer.

Step 220: End.

The interface unit 124 receives read/write commands from the host 150, and the control circuit 114 controls the optical storage apparatus 100 to record information onto/reproduce information from the multi-layer optical storage medium 101 in response to the received read/write commands. In this exemplary embodiment, when the interface unit 124 receives a layer jump request REQ for moving a focus point from a first recording layer of the multi-layer optical storage medium 101 to a second recording layer of the optical storage medium 101, the control circuit 114 enables a layer jump control mechanism to serve the layer jump request REQ (step 202). In response to the layer jump request REQ, the laser power decision unit 126 generates a laser power control signal S1 to the power controller 110 for adjusting a laser power of the laser beam 105 (step 206). Thus, the laser power of the laser beam 105 irradiating the multi-layer optical storage medium 101 is adjusted to be a second power level different from a first power level, wherein the first power level is defined for reproducing information from the first recording layer, and the second power level is defined for reproducing information from the second recording layer.

More specifically, each of the first power level and the second power level is a read power level utilized when the optical storage apparatus 100 enters a read mode. Thus, before desired data is reproduced from a target recording layer of the multi-layer optical storage medium 101, the information (such as data or address) on the target recording layer could be identified using a laser beam. Thus, in addition to reproducing the desired data from a recording layer, the read power level, for example, can be defined for identifying address information from the recording layer.

Besides, the layer jump control unit 128 generates a servo control signal S2 to the servo system 112 for moving the focus point from the first recording layer to the second recording layer. Therefore, the tracking servo controller 118 turns off the tracking servo control by the servo control signal S2 (step 204). In addition, as a closed-loop focus servo control is generally activated to make the focus point stay at a desired recording layer, the closed-loop focus servo control is required to be disabled for allowing the focus point to move from the current recording layer to another recording layer. Therefore, the focus servo controller 116 turns off the closed-loop focus servo control by the servo control signal S2 (step 208). In this embodiment, the focus point moves immediately after the closed-loop focus servo control is turned off (steps 208 and 210). However, this is for illustrative purposes only and is not meant to be a limitation to the scope of the present invention.

In this exemplary embodiment, the laser power decision unit 126 may has a lookup table which stores a first power level utilized for reproducing information from the first recording layer, and a second power level utilized for reproducing information from the second recording layer. By way of example, the multi-layer optical storage medium 101 is an optical disc (e.g., CD, DVD, or BD) with at least two layers including the first recording layer and the second recording layer, wherein the characteristic of the first recording layer is different from that of the second recording layer. Therefore, the second power level for the second recording layer is different from the first power level for the first recording layer. The power controller 110 therefore adjusts the laser power of the laser beam 105 from a current power level to the second power level.

In addition, the conventional servo compensation is enabled as the laser power is changed. It should be noted that as no data recording can be performed during the focus point movement between the first recording layer and the second recording layer, the optical storage apparatus 100 should enter a read mode when the layer jump operation is enabled. Therefore, in a case where the optical storage apparatus 100 receives the layer jump request REQ from the host 150 when recording information onto the first recording layer, the power controller 110 adjusts the laser power of the laser beam 105 from a write power level to the second power level which is a read power level. In another case where the optical storage apparatus 100 receives the layer jump request REQ from the host 150 when reproducing information from the first recording layer, the power controller 110 adjusts the laser power of the laser beam 105 from the first power level to the second power level, where both of the first power level and the second power level are read power levels.

Regarding the first exemplary layer jump method, adjusting the laser power of the laser beam to the second power level is accomplished prior to moving the focus point from the first recording layer to the second recording layer. Therefore, after the power change of the OPU 104 is done, the focus servo controller 116, operated under an open-loop focus servo control mode, starts moving the focus point from the first recording layer toward the second recording layer in a thickness direction (i.e., a vertical direction or interlayer direction of the multi-layer optical storage medium 101). The reflected laser beam is detected when the OPU 104 emits the laser beam 105 with the second power level. Thus, the signal processor 108 generates an indication signal, indicative of the focus point movement status, to the control circuit 114. For example, the focus error signal FE can be used to serve as the indication signal. The layer jump control unit 128 monitors the indication signal to check if the focus point reaches an in-focus point position of the second recording layer (step 212). When the focus point reaches the in-focus point position of the second recording layer, the focus servo controller 116 turns on the closed-loop focus servo control by the servo control signal S2 (step 214). In addition, the tracking servo controller 118 turns on the tracking servo control by the servo control signal S2 (step 216).

After the focus point is focused on the second recording layer, the laser beam 105 with the second target power will be used to reproduce information (e.g., address information) from the second recording layer for resuming a previous task interrupted by the layer jump request or starting a new task. For example, in a case where the optical storage apparatus 100 receives the layer jump request REQ from the host 150 when recording information onto the first recording layer, the power controller 110 adjusts the laser power of the laser beam 105 from the second target level to a write power level for continuing the data recording task on the second recording layer. In another case where the optical storage apparatus 100 receives the layer jump request REQ from the host 150 when reproducing information from the first recording layer, the OPU 104 keeps using the laser beam 105 with the laser power set to the second power level for continuing the data reproducing task on the second recording layer.

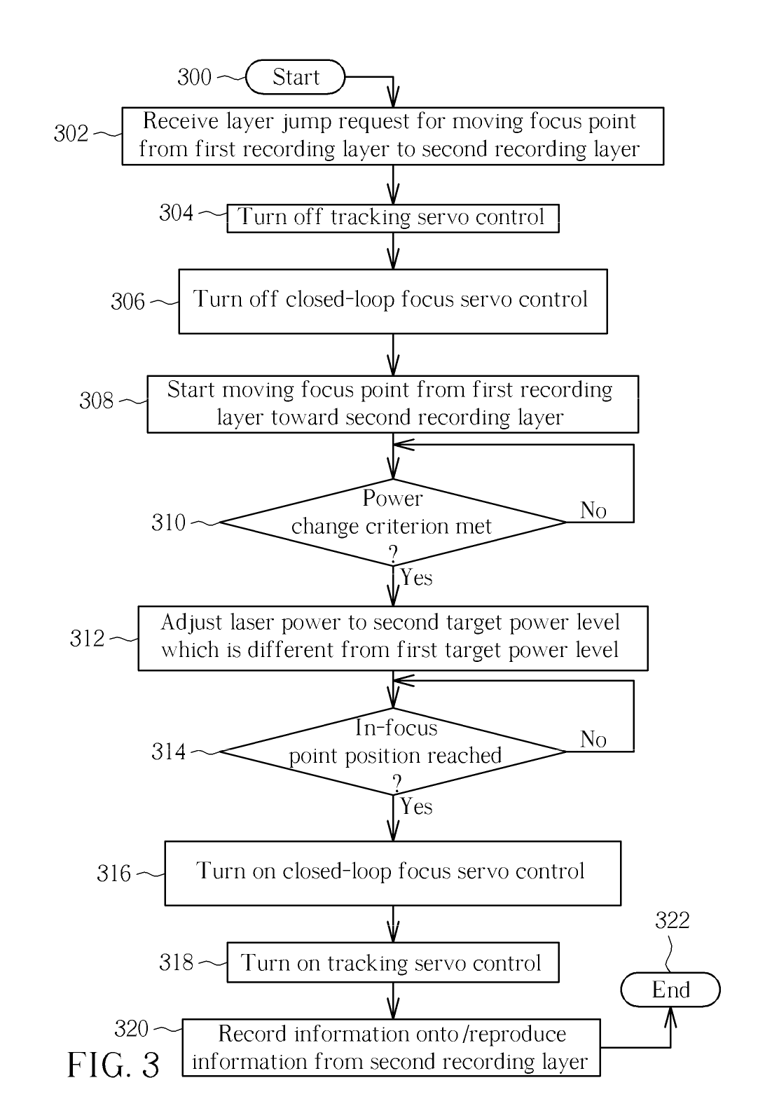

Please refer to FIG. 3 in conjunction with FIG. 1. FIG. 3 is a flowchart illustrating a second exemplary layer jump method for the multi-layer optical storage medium 101 according to the present invention. Provided that the result is substantially the same, the steps are not required to be executed in the exact order shown in FIG. 3. The second exemplary layer jump method performed by the optical storage apparatus 100 includes the following steps.

Step 300: Start.

Step 302: Receive a layer jump request for moving a focus point from a first recording layer of a multi-layer optical storage medium to a second recording layer of the optical storage medium.

Step 304: Turn off a tracking servo control.

Step 306: Turn off a closed-loop focus servo control.

Step 308: Start moving the focus point from the first recording layer toward the second recording layer in a thickness direction.

Step 310: Check if a power change criterion is met. If yes, go to step 312;

otherwise, perform step 310 again.

Step 312: Adjust a laser power of a laser beam irradiating the multi-layer optical storage medium to a second power level different from a first power level, wherein the first power level is utilized for reproducing information (e.g., identifying information, such as data or address) from the first recording layer, and the second power level is utilized for reproducing information (e.g., identifying information, such as data or address) from the second recording layer.

Step 314: Check if the focus point reaches an in-focus point position of the second recording layer. If yes, go to step 316; otherwise, perform step 314 again.

Step 316: Turn on the closed-loop focus servo control.

Step 318: Turn on the tracking servo control.

Step 320: Record information onto or reproduce information from the second recording layer.

Step 322: End.

The second exemplary layer jump method shown in FIG. 3 is similar to the first exemplary layer jump method shown in FIG. 1. The major difference therebetween is the timing of changing the laser power of the laser beam 105 emitted from the OPU 104. Specifically, regarding the second exemplary layer jump method, adjusting the laser power of the laser beam to the second power level is accomplished during a time period of moving the focus point from the first recording layer to the second recording layer. Therefore, after the focus servo controller 116 starts moving the focus point from the first recording layer toward the second recording layer in the thickness direction of the multi-layer optical storage medium 101, the layer jump control unit 128 checks if a power change criterion is met (step 310). By way of example, but not limitation, the layer jump control unit 128 may determine that the power change criterion is met when a predetermined time point within the time period of moving the focus point from the first recording layer to the second recording layer is reached; alternatively, the layer jump control unit 128 may determine that the power change criterion is met when the focus point is moved to a predetermined position between the first recording layer and the second recording layer. It should be noted that when the focus error signal FE acts as the required indication signal indicative of the focus point movement status, the focus error signal FE will have an S-curve each time the focus point passes through a boundary between different layers. If the laser power is changed while the focus point is passing through the boundary between different layers, the generated S-curve used for indicating that the focus point moves from one layer to another layer may be effected. To avoid this, the predetermined time point/predetermined position should be properly designed such that the laser power is prevented from being changed while the focus point is passing through the boundary between different layers. After the power change criterion is met, the power controller 112 adjusts the laser power of the laser beam 105 to the second power level according to the laser power control signal 51 (step 312).

In regard to other steps included in the second exemplary layer jump method shown in FIG. 3, as a person skilled in the art can readily understand details of these steps after reading above paragraphs directed to the first exemplary layer jump method shown in FIG. 2, further description is omitted here for brevity.

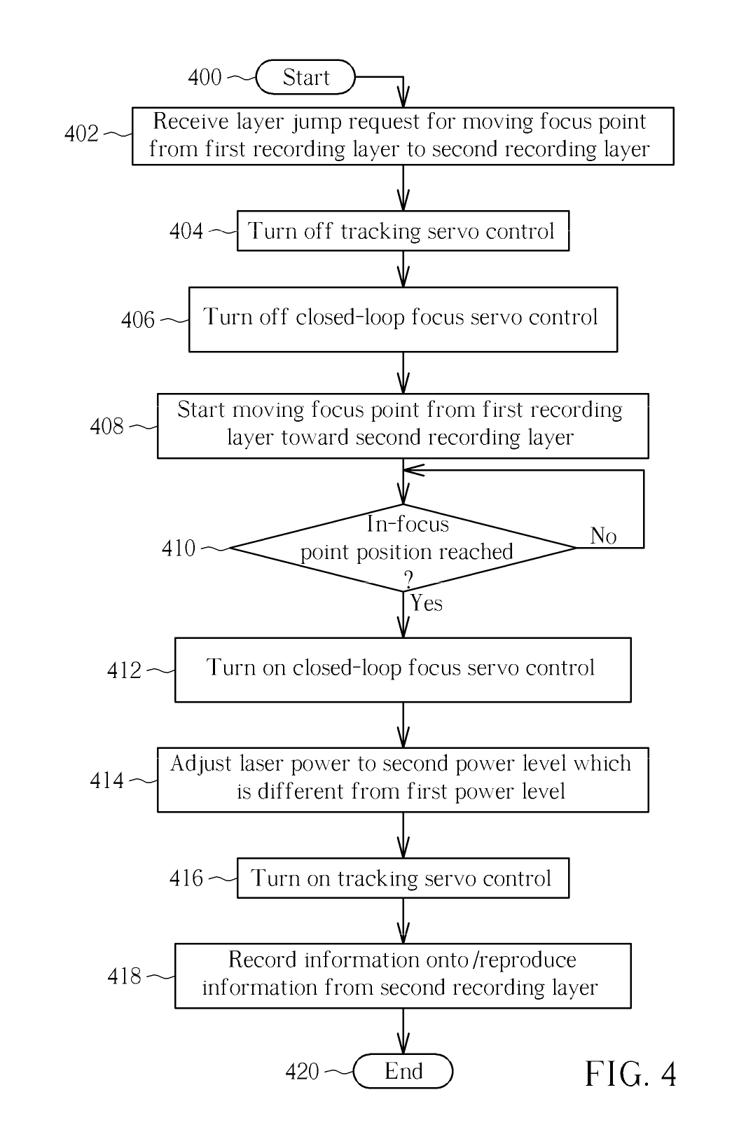

Please refer to FIG. 4 in conjunction with FIG. 1. FIG. 4 is a flowchart illustrating a third exemplary layer jump method for the multi-layer optical storage medium 101 according to the present invention. Provided that the result is substantially the same, the steps are not required to be executed in the exact order shown in FIG. 4. The third exemplary layer jump method performed by the optical storage apparatus 100 includes the following steps.

Step 400: Start.

Step 402: Receive a layer jump request for moving a focus point from a first recording layer of a multi-layer optical storage medium to a second recording layer of the optical storage medium.

Step 404: Turn off a tracking servo control.

Step 406: Turn off a closed-loop focus servo control.

Step 408: Start moving the focus point from the first recording layer toward the second recording layer in a thickness direction.

Step 410: Check if the focus point reaches an in-focus point position of the second recording layer. If yes, go to step 412; otherwise, perform step 410 again.

Step 412: Turn on the closed-loop focus servo control.

Step 414: Adjust a laser power of a laser beam irradiating the multi-layer optical storage medium to a second power level different from a first power level, wherein the first power level is utilized for reproducing information (e.g., identifying information, such as data or address) from the first recording layer, and the second power level is utilized for reproducing information (e.g., identifying information, such as data or address) from the second recording layer.

Step 416: Turn on the tracking servo control.

Step 418: Record information onto or reproduce information from the second recording layer.

Step 420: End.

The third exemplary layer jump method shown in FIG. 4 is similar to the first exemplary layer jump method shown in FIG. 1. The major difference therebetween is the timing of changing the laser power of the laser beam 105 emitted from the OPU 104. Regarding the third exemplary layer jump method, moving the focus point from the first recording layer to the second recording layer is accomplished prior to adjusting the laser power of the laser beam to the second power level. Therefore, after the focus servo controller 116 has moved the focus point from the first recording layer to the second recording layer, the power controller 112 adjusts the laser power of the laser beam 105 to the second power level according to the laser power control signal 51 (step 414). In regard to other steps included in the second exemplary layer jump method, as a person skilled in the art can readily understand details of these steps after reading above paragraphs directed to the first exemplary layer jump method, further description is omitted here for brevity.

Regarding the first exemplary layer jump method, the laser power is changed before the focus point starts moving from one recording layer (i.e., the aforementioned first recording layer) to another recording layer (i.e., the aforementioned second recording layer). Therefore, the servo system 112 requires two sets of servo parameters for different laser power levels used for accessing one recording layer (e.g., the aforementioned first recording layer). Regarding the third exemplary layer jump method, the laser power is changed after the focus point has moved to another recording layer (i.e., the aforementioned second recording layer). Similarly, the servo system 112 requires two sets of servo parameters for different laser power levels used for accessing one recording layer (e.g., the second recording layer). However, regarding the second exemplary layer jump method, the laser power is changed during the time period of moving the focus point from one recording layer (i.e., the aforementioned first recording layer) to another recording layer (i.e., the aforementioned second recording layer). As the servo control effort is reduced when the focus point is moved due to layer jump, the servo parameter setting can be simplified. In short, compared to the first exemplary layer jump method and the third exemplary layer jump method, the second exemplary layer jump method may be preferably employed by the optical storage device 100. However, this is for illustrative purposes only and is not meant to be taken as a limitation to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for controlling access of a multi-layer optical storage medium, comprising:
receiving a layer jump request for moving a focus point from a first recording layer of the multi-layer optical storage medium to a second recording layer of the multi-layer optical storage medium; and
in response to the layer jump request, adjusting a laser power of a laser beam irradiating the multi-layer optical storage medium from a first power level to a second power level, wherein the first power level is utilized for reproducing information from the first recording layer, and the second power level is utilized for reproducing information from the second recording layer.

2. The control method of claim 1, further comprising:
moving the focus point from the first recording layer to the second recording layer in response to the layer jump request;
wherein adjusting the laser power of the laser beam to the second power level is accomplished prior to moving the focus point from the first recording layer to the second recording layer.

3. The control method of claim 1, further comprising:
moving the focus point from the first recording layer to the second recording layer in response to the layer jump request;
wherein adjusting the laser power of the laser beam to the second power level is accomplished during a time period of moving the focus point from the first recording layer to the second recording layer.

4. The control method of claim 3, wherein adjusting the laser power of the laser beam comprises:
checking if a power change criterion is met; and
when the power change criterion is met, adjusting the laser power of the laser beam.

5. The control method of claim 4, wherein the power change criterion is met when a predetermined time point within the time period of moving the focus point from the first recording layer to the second recording layer is reached.

6. The control method of claim 4, wherein the power change criterion is met when the focus point is moved to a predetermined position between the first recording layer and the second recording layer.

7. The control method of claim 1, further comprising:
moving the focus point from the first recording layer to the second recording layer in response to the layer jump request;
wherein moving the focus point from the first recording layer to the second recording layer is accomplished prior to adjusting the laser power of the laser beam to the second power level.

8. The control method of claim 1, wherein the multi-layer optical storage medium is an optical disc with at least two layers including the first recording layer and the second recording layer.

9. A control circuit of an optical storage apparatus, comprising:
an interface unit, arranged to receive a layer jump request for moving a focus point from a first recording layer of a multi-layer optical storage medium to a second recording layer of the multi-layer optical storage medium; and
a laser power decision unit, arranged to generate a laser power control signal to a power controller of the optical storage apparatus for adjusting a laser power of a laser beam irradiating the multi-layer optical storage medium from a first power level to a second power level in response to the layer jump request, wherein the first power level is utilized for reproducing information from the first recording layer, and the second power level is utilized for reproducing information from the second recording layer.

10. The control circuit of claim 9, further comprising:
a layer jump control unit, arranged to generate a servo control signal to a servo system of the optical storage apparatus for moving the focus point from the first recording layer to the second recording layer in response to the layer jump request;
wherein the laser power decision unit generates the laser power control signal to the power controller for adjusting the laser power of the laser beam before the layer jump control unit generates the servo control signal to the servo system for moving the focus point.

11. The control circuit of claim 9, further comprising:
a layer jump control unit, arranged to generate a servo control signal to a servo system of the optical storage apparatus for moving the focus point from the first recording layer to the second recording layer in response to the layer jump request;
wherein the laser power decision unit generates the laser power control signal during a time period of moving the focus point from the first recording layer to the second recording layer.

12. The control circuit of claim 11, wherein the laser power decision unit checks if a power change criterion is met, and when the power change criterion is met, the laser power decision unit generates the laser power control signal to the power controller of the optical storage apparatus.

13. The control circuit of claim 12, wherein when a predetermined time point within the time period of moving the focus point from the first recording layer to the second recording layer is reached, the laser power decision unit determines that the power change criterion is met.

14. The control circuit of claim 12, wherein when the focus point is moved to a predetermined position between the first recording layer and the second recording layer, the laser power decision unit determines that the power change criterion is met.

15. The control circuit of claim 9, further comprising:
a layer jump control unit, arranged to generate a servo control signal to a servo system of the optical storage apparatus for moving the focus point from the first recording layer to the second recording layer in response to the layer jump request;
wherein the layer jump control unit generates the servo control signal to the servo system for moving the focus point before the laser power decision unit generates the laser power control signal for adjusting the laser power of the laser beam.

16. The control circuit of claim 9, wherein the multi-layer optical storage medium is an optical disc with at least two layers including the first recording layer and the second recording layer.

17. A control method for controlling access of a multi-layer optical storage medium, comprising:
receiving a layer jump request for moving a focus point from a first recording layer of the multi-layer optical storage medium to a second recording layer of the multi-layer optical storage medium; and
in response to the layer jump request, generating a laser power control signal to a power controller for adjusting a laser power of a laser beam irradiating the multi-layer optical storage medium from a first power level to a second power level , wherein the first power level is utilized for identifying information from the first recording layer, and the second power level is utilized for identifying information from the second recording layer.

18. The control method of claim 17, further comprising:
generating a servo control signal to a servo system of the optical storage apparatus for moving the focus point from the first recording layer to the second recording layer in response to the layer jump request;
wherein the laser power control signal is generated to the power controller for adjusting the laser power of the laser beam before the servo control signal is generated to the servo system for moving the focus point.

19. The control method of claim 17, further comprising:
generating a servo control signal to a servo system of the optical storage apparatus for moving the focus point from the first recording layer to the second recording layer in response to the layer jump request;
wherein the laser power control signal is generated to the power controller for adjusting the laser power of the laser beam during a time period of moving the focus point from the first recording layer to the second recording layer.

20. The control method of claim 19, wherein generating the laser power control signal comprises:
checking if a power change criterion is met; and
when the power change criterion is met, generating the laser power control signal to the power controller of the optical storage apparatus.

21. The control method of claim 20, wherein when a predetermined time point within the time period of moving the focus point from the first recording layer to the second recording layer is reached, the power change criterion is met.

22. The control method of claim 20, wherein when the focus point is moved to a predetermined position between the first recording layer and the second recording layer, the power change criterion is met.

23. The control method of claim 17, further comprising:
generating a servo control signal to a servo system of the optical storage apparatus for moving the focus point from the first recording layer to the second recording layer in response to the layer jump request;
wherein the servo control signal is generated to the servo system for moving the focus point before the laser power control signal is generated for adjusting the laser power of the laser beam.

24. The control method of claim 17, wherein the multi-layer optical storage medium is an optical disc with at least two layers including the first recording layer and the second recording layer.

25. A control method for controlling access of a multi-layer optical storage medium, comprising:
setting a laser power of a laser beam irradiating a first recording layer of the multi-layer optical storage medium to a first power level when reproducing information from the first recording layer; and
setting the laser power of the laser beam irradiating a second recording layer of the multi-layer optical storage medium to a second power level when reproducing information from the second recording layer;
wherein the first power level is different from the second power level.
